(19) United States
(12) Patent Application Publication
(10) Pub. No.: US 2024/0202822 A1
(43) Pub. Date: Jun. 20, 2024

(54) METHOD AND SYSTEM FOR DETECTION OF ANOMALOUS REJECTIONS OF FOREIGN EXCHANGE REQUESTS

(71) Applicant: JPMorgan Chase Bank, N.A., New York, NY (US)

(72) Inventors: Nacho NAVARRO, Storrs, CT (US); Xiaomo LIU, Manhasset, NY (US); Simran LAMBA, Manhattan, NY (US); Akshat GUPTA, New York, NY (US); Sameena SHAH, Scarsdale, NY (US)

(73) Assignee: JPMorgan Chase Bank, N.A., New York, NY (US)

(21) Appl. No.: 18/085,104

(22) Filed: Dec. 20, 2022

(51) Int. Cl. G06Q 40/04

(52) U.S. Cl. CPC G06Q 40/04

(57) ABSTRACT

A method and a system for detecting abnormal and/or anomalous rejections of requests for quotes for foreign exchange transactions are provided. The method includes: receiving a request for quote (RFQ) that relates to a proposed foreign exchange (FX) transaction; retrieving first information that relates to a financial capability of the requester to conduct the proposed FX transaction; applying a first algorithm that is designed to make an initial determination as to whether the RFQ is acceptable, based on the RFQ and the first information; when the initial determination indicates that the RFQ is not acceptable, applying a second algorithm that uses an artificial intelligence (AI) technique to determine a potential reason that the initial determination has indicated that the RFQ is not acceptable; and generating a report that includes information that relates to the potential reason that the initial determination has indicated that the RFQ is not acceptable.

### BACKGROUND

### 1. Field of the Disclosure

This technology generally relates to methods and systems for detecting abnormal and/or anomalous rejections of requests for quotes for foreign exchange transactions by using artificial intelligence techniques to obtain explanations for the rejections and to facilitate resolutions thereof so as to minimize potential losses of revenue.

### 2. Background Information

Financial institutions, such as banks, facilitate voluminous numbers of transactions for their clients on a daily basis, as part of the regular conduct of commercial business activities. Many such transactions involve foreign exchange.

Foreign exchange transactions typically are initiated by a request for quote that is received from a customer or potential customer. The number of such requests for quote may be on the order of tens or hundreds of thousands per day. As a result, many banks use conventional pricing algorithms to determine whether such requests for quote are to be accepted or rejected.

Typically, a conventional pricing algorithm determines that a small but significant percentage of requests for quotes with respect to foreign exchange transactions are to be rejected. For example, approximately 10%-15% of such requests may be rejected. In addition, when such a request is rejected, the conventional pricing algorithm does not provide an explanation as to a reason for the rejection.

In this regard, in many situations, there may be a circumstance that has caused the algorithm to reject the request that would be resolvable if a specialist was aware of the circumstance, but because of the volume of requests, it is typically not feasible to make specialists aware of such situations. As a result, there is no opportunity to resolve an issue that has caused the rejection, and in addition, the customer for whom the request has been rejected may complain and may shift its business to another bank. This, in turn, causes an irreplaceable loss of revenue.

Accordingly, there is a need for a method for detecting abnormal and/or anomalous rejections of requests for quotes for foreign exchange transactions by using artificial intelligence techniques to obtain explanations for the rejections and to facilitate resolutions thereof so as to minimize potential losses of revenue.

### SUMMARY

The present disclosure, through one or more of its various aspects, embodiments, and/or specific features or sub-components, provides, inter alia, various systems, servers, devices, methods, media, programs, and platforms for detecting abnormal and/or anomalous rejections of requests for quotes for foreign exchange transactions by using artificial intelligence techniques to obtain explanations for the rejections and to facilitate resolutions thereof so as to minimize potential losses of revenue.

According to an aspect of the present disclosure, a method for detecting anomalous rejections of requests for quotes for foreign exchange transactions is provided. The method is implemented by at least one processor. The method includes: receiving, by the at least one processor from a first entity, a first request for quote (RFQ) that relates to a proposed foreign exchange (FX) transaction; retrieving, by the at least one processor from a memory, first information that relates to a financial capability of the first entity to conduct the proposed FX transaction; applying, by the at least one processor, a first algorithm that is designed to make an initial determination as to whether the first RFQ is acceptable, based on the first RFQ and the first information; when the initial determination indicates that the first RFQ is not acceptable, applying, by the at least one processor, a second algorithm that uses an artificial intelligence (AI) technique to determine a potential reason that the initial determination has indicated that the first RFQ is not acceptable; and generating a report that includes information that relates to the potential reason that the initial determination has indicated that the first RFQ is not acceptable.

The potential reason may include at least one from among a first reason that is based on an abnormal behavior of the first entity within a predetermined time interval, a second reason that is based on a product type that relates to the proposed FX transaction, a third reason that is based on a currency that relates to the proposed FX transaction, and a fourth reason that is based on a size of the proposed FX transaction.

The predetermined time interval may include one from among a 24-hour interval, a three-day interval, a seven-day interval, a 30-day interval, a six-month interval, and a twelve-month interval.

The second algorithm may use historical information that relates to previous transactions that have been conducted by the first entity as an input.

The second algorithm may use historical information that relates to previous transactions that have been conducted by a plurality of second entities that are similar to the first entity as an additional input.

The second algorithm may use historical information that relates to previous transactions that have been conducted by a plurality of third entities that are not similar to the first entity as another additional input.

The method may further include determining whether a particular entity is similar to the first entity by: identifying a plurality of features that relates to the first entity; identifying, for each respective entity from among a global set of entities, a corresponding set of features that relates to the respective entity; determining, for each respective pairing of a respective entity with the first entity, a respective distance between the plurality of features that relates to the first entity and the corresponding set of features that relates to the respective entity; and determining, for each respective pairing, whether the corresponding entity is similar to the first entity based on the determined distance.

Each entity included in the global set of entities that is not determined as being similar to the first entity may be determined as being included in the plurality of third entities.

The method may further include transmitting the report to a predetermined destination and displaying at least a portion of the report on a display via a graphical user interface (GUI).

According to another exemplary embodiment, a computing apparatus for detecting anomalous rejections of requests for quotes for foreign exchange transactions is provided. The computing apparatus includes a processor; a memory; a display; and a communication interface coupled to each of the processor, the memory, and the display. The processor is configured to: receive, via the communication interface from a first entity, a first request for quote (RFQ) that relates to a proposed foreign exchange (FX) transaction; retrieve, from the memory, first information that relates to a financial capability of the first entity to conduct the proposed FX transaction; apply a first algorithm that is designed to make an initial determination as to whether the first RFQ is acceptable, based on the first RFQ and the first information; when the initial determination indicates that the first RFQ is not acceptable, apply a second algorithm that uses an artificial intelligence (AI) technique to determine a potential reason that the initial determination has indicated that the first RFQ is not acceptable; and generate a report that includes information that relates to the potential reason that the initial determination has indicated that the first RFQ is not acceptable.

The potential reason may include at least one from among a first reason that is based on an abnormal behavior of the first entity within a predetermined time interval, a second reason that is based on a product type that relates to the proposed FX transaction, a third reason that is based on a currency that relates to the proposed FX transaction, and a fourth reason that is based on a size of the proposed FX transaction.

The predetermined time interval may include one from among a 24-hour interval, a three-day interval, a seven-day interval, a 30-day interval, a six-month interval, and a twelve-month interval.

The second algorithm may use historical information that relates to previous transactions that have been conducted by the first entity as an input.

The second algorithm may use historical information that relates to previous transactions that have been conducted by a plurality of second entities that are similar to the first entity as an additional input.

The second algorithm may use historical information that relates to previous transactions that have been conducted by a plurality of third entities that are not similar to the first entity as another additional input.

The processor may be further configured to determine whether a particular entity is similar to the first entity by: identifying a plurality of features that relates to the first entity; identifying, for each respective entity from among a global set of entities, a corresponding set of features that relates to the respective entity; determining, for each respective pairing of a respective entity with the first entity, a respective distance between the plurality of features that relates to the first entity and the corresponding set of features that relates to the respective entity; and determining, for each respective pairing, whether the corresponding entity is similar to the first entity based on the determined distance.

Each entity included in the global set of entities that is not determined as being similar to the first entity may be determined as being included in the plurality of third entities.

The processor may be further configured to transmit, via the communication interface, the report to a predetermined destination and to cause the display to display at least a portion of the report via a graphical user interface (GUI).

According to yet another exemplary embodiment, a non-transitory computer readable storage medium storing instructions for detecting anomalous rejections of requests for quotes for foreign exchange transactions is provided. The storage medium includes executable code which, when executed by a processor, causes the processor to: receive, from a first entity, a first request for quote (RFQ) that relates to a proposed foreign exchange (FX) transaction; retrieve, from a memory, first information that relates to a financial capability of the first entity to conduct the proposed FX transaction; apply a first algorithm that is designed to make an initial determination as to whether the first RFQ is acceptable, based on the first RFQ and the first information; when the initial determination indicates that the first RFQ is not acceptable, apply a second algorithm that uses an artificial intelligence (AI) technique to determine a potential reason that the initial determination has indicated that the first RFQ is not acceptable; and generate a report that includes information that relates to the potential reason that the initial determination has indicated that the first RFQ is not acceptable.

The potential reason may include at least one from among a first reason that is based on an abnormal behavior of the first entity within a predetermined time interval, a second reason that is based on a product type that relates to the proposed FX transaction, a third reason that is based on a currency that relates to the proposed FX transaction, and a fourth reason that is based on a size of the proposed FX transaction.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for detecting abnormal and/or anomalous rejections of requests for quotes for foreign exchange transactions by using artificial intelligence techniques to obtain explanations for the rejections and to facilitate resolutions thereof so as to minimize potential losses of revenue.

FIG. 4 is a flowchart of an exemplary process for implementing a method for detecting abnormal and/or anomalous rejections of requests for quotes for foreign exchange transactions by using artificial intelligence techniques to obtain explanations for the rejections and to facilitate resolutions thereof so as to minimize potential losses of revenue.

FIG. 5 is a diagram that illustrates a timeline for detecting abnormal behavior, generating an anomaly alert, and performing a remediation action in a method for detecting abnormal and/or anomalous rejections of requests for quotes for foreign exchange transactions, according to an exemplary embodiment.

FIG. 6 is a diagram that illustrates various scenarios in which rejections of requests for quotes are determined as being normal or abnormal in a method for detecting abnormal and/or anomalous rejections of requests for quotes for foreign exchange transactions, according to an exemplary embodiment, according to an exemplary embodiment.

FIG. 7 is a diagram that illustrates a timeline for performing a dynamic anomaly detection in a method for detecting abnormal and/or anomalous rejections of requests for quotes for foreign exchange transactions, according to an exemplary embodiment, according to an exemplary embodiment.

FIG. 8 is a diagram that illustrates a procedure for determining a distribution of a deviation and a distance with respect to a numerical feature that relates to a reason for a rejection in a method for detecting abnormal and/or anomalous rejections of requests for quotes for foreign exchange transactions, according to an exemplary embodiment, according to an exemplary embodiment.

FIG. 9 is a diagram that illustrates a procedure for determining a distribution of a deviation and a distance with respect to a categorical feature that relates to a reason for a rejection in a method for detecting abnormal and/or anomalous rejections of requests for quotes for foreign exchange transactions, according to an exemplary embodiment, according to an exemplary embodiment.

FIG. 10 is a diagram that illustrates a procedure for determining a similarity among transaction participants in a method for detecting abnormal and/or anomalous rejections of requests for quotes for foreign exchange transactions, according to an exemplary embodiment, according to an exemplary embodiment.

FIG. 11 is a diagram that illustrates a procedure for determining whether a rejection is anomalous or normal in a method for detecting abnormal and/or anomalous rejections of requests for quotes for foreign exchange transactions, according to an exemplary embodiment, according to an exemplary embodiment.

FIG. 12 is a diagram that illustrates a graphical user interface (GUI) that displays an RFQ abnormal detection report that is generated by performing a method for detecting abnormal and/or anomalous rejections of requests for quotes for foreign exchange transactions, according to an exemplary embodiment.

FIG. 13 is a screenshot that illustrates an example of an RFQ abnormal detection report that is generated by performing a method for detecting abnormal and/or anomalous rejections of requests for quotes for foreign exchange transactions, according to an exemplary embodiment.

FIG. 14 is a diagram that illustrates a logic flow of a system that performs a method for detecting abnormal and/or anomalous rejections of requests for quotes for foreign exchange transactions, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

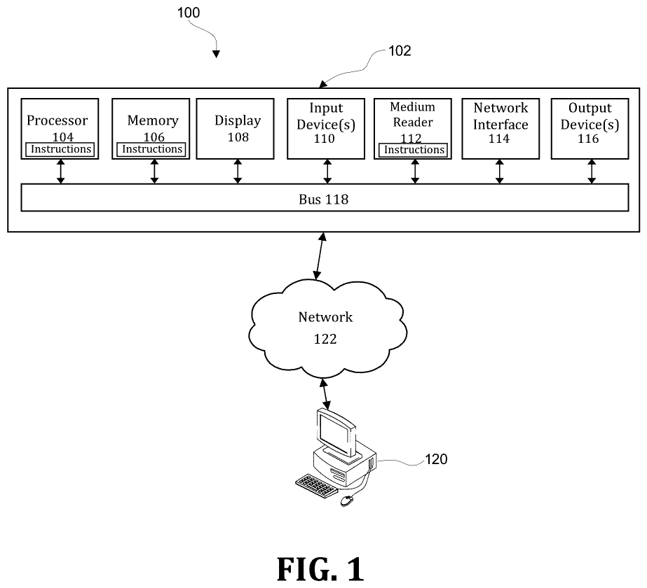

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC).

The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for detecting abnormal and/or anomalous rejections of requests for quotes (RFQs) for foreign exchange (FX) transactions by using artificial intelligence techniques to obtain explanations for the rejections and to facilitate resolutions thereof so as to minimize potential losses of revenue.

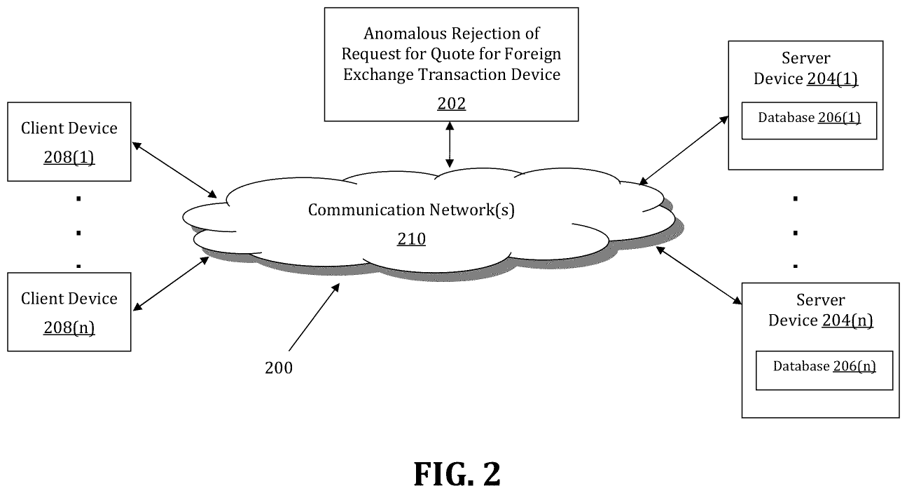

Referring to FIG. 2, a schematic of an exemplary network environment 200 for implementing a method for detecting abnormal and/or anomalous rejections of RFQs for FX transactions by using artificial intelligence techniques to obtain explanations for the rejections and to facilitate resolutions thereof so as to minimize potential losses of revenue is illustrated. In an exemplary embodiment, the method is executable on any networked computer platform, such as, for example, a personal computer (PC).

The method for detecting abnormal and/or anomalous rejections of RFQs for FX transactions by using artificial intelligence techniques to obtain explanations for the rejections and to facilitate resolutions thereof so as to minimize potential losses of revenue may be implemented by an Anomalous Rejection of Request For Quote for Foreign exchange Transaction (ARRFQFXT) device 202. The ARRFQFXT device 202 may be the same or similar to the computer system 102 as described with respect to FIG. 1. The ARRFQFXT device 202 may store one or more applications that can include executable instructions that, when executed by the ARRFQFXT device 202, cause the ARRFQFXT device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the ARRFQFXT device 202 itself, may be located in virtual server(s) running in a cloud-based computing environment rather than being tied to one or more specific physical network computing devices. Also, the application(s) may be running in one or more virtual machines (VMs) executing on the ARRFQFXT device 202. Additionally, in one or more embodiments of this technology, virtual machine(s) running on the ARRFQFXT device 202 may be managed or supervised by a hypervisor.

In the network environment 200 of FIG. 2, the ARRFQFXT device 202 is coupled to a plurality of server devices 204(1)-204(n) that hosts a plurality of databases 206(1)-206(n), and also to a plurality of client devices 208(1)-208(n) via communication network(s) 210. A communication interface of the ARRFQFXT device 202, such as the network interface 114 of the computer system 102 of FIG. 1, operatively couples and communicates between the ARRFQFXT device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ARRFQFXT device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and ARRFQFXT devices that efficiently implement a method for detecting abnormal and/or anomalous rejections of RFQs for FX transactions by using artificial intelligence techniques to obtain explanations for the rejections and to facilitate resolutions thereof so as to minimize potential losses of revenue.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The ARRFQFXT device 202 may be a standalone device or integrated with one or more other devices or apparatuses, such as one or more of the server devices 204(1)-204(n), for example. In one particular example, the ARRFQFXT device 202 may include or be hosted by one of the server devices 204(1)-204(n), and other arrangements are also possible. Moreover, one or more of the devices of the ARRFQFXT device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the ARRFQFXT device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store customer-specific information that relates to financial accounts and data that relates to criteria for conducting foreign exchange transactions.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the ARRFQFXT device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the ARRFQFXT device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the ARRFQFXT device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the ARRFQFXT device 202, the server devices 204(1)-204(n), or the client devices 208(1)-208(n), for example, may be configured to operate as virtual instances on the same physical machine. In other words, one or more of the ARRFQFXT device 202, the server devices 204(1)-204(n), or the client devices 208(1)-208(n) may operate on the same physical device rather than as separate devices communicating through communication network(s) 210. Additionally, there may be more or fewer ARRFQFXT devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

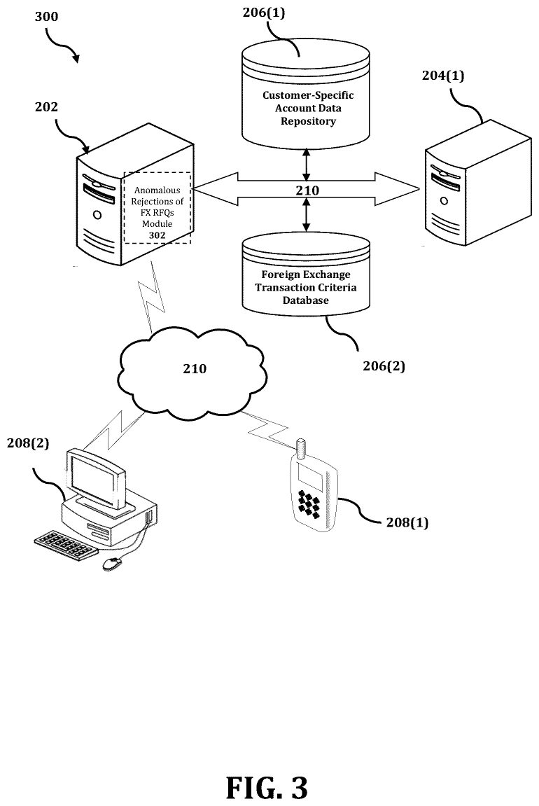

The ARRFQFXT device 202 is described and illustrated in FIG. 3 as including an anomalous rejections of foreign exchange (FX) requests for quote (RFQs) module 302, although it may include other rules, policies, modules, databases, or applications, for example. As will be described below, the anomalous rejection of FX RFQs module 302 is configured to implement a method for detecting abnormal and/or anomalous rejections of requests for quotes for foreign exchange transactions by using artificial intelligence techniques to obtain explanations for the rejections and to facilitate resolutions thereof so as to minimize potential losses of revenue.

An exemplary process 300 for implementing a mechanism for detecting abnormal and/or anomalous rejections of RFQs for FX transactions by using artificial intelligence techniques to obtain explanations for the rejections and to facilitate resolutions thereof so as to minimize potential losses of revenue by utilizing the network environment of FIG. 2 is illustrated as being executed in FIG. 3. Specifically, a first client device 208(1) and a second client device 208(2) are illustrated as being in communication with ARRFQFXT device 202. In this regard, the first client device 208(1) and the second client device 208(2) may be “clients” of the ARRFQFXT device 202 and are described herein as such. Nevertheless, it is to be known and understood that the first client device 208(1) and/or the second client device 208(2) need not necessarily be “clients” of the ARRFQFXT device 202, or any entity described in association therewith herein. Any additional or alternative relationship may exist between either or both of the first client device 208(1) and the second client device 208(2) and the ARRFQFXT device 202, or no relationship may exist.

Further, ARRFQFXT device 202 is illustrated as being able to access a customer-specific account data repository 206(1) and a foreign exchange transaction criteria database 206(2). The anomalous rejections of FX RFQs module 302 may be configured to access these databases for implementing a method for detecting abnormal and/or anomalous rejections of RFQs for FX transactions by using artificial intelligence techniques to obtain explanations for the rejections and to facilitate resolutions thereof so as to minimize potential losses of revenue.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the ARRFQFXT device 202 via broadband or cellular communication. Of course, these embodiments are merely exemplary and are not limiting or exhaustive.

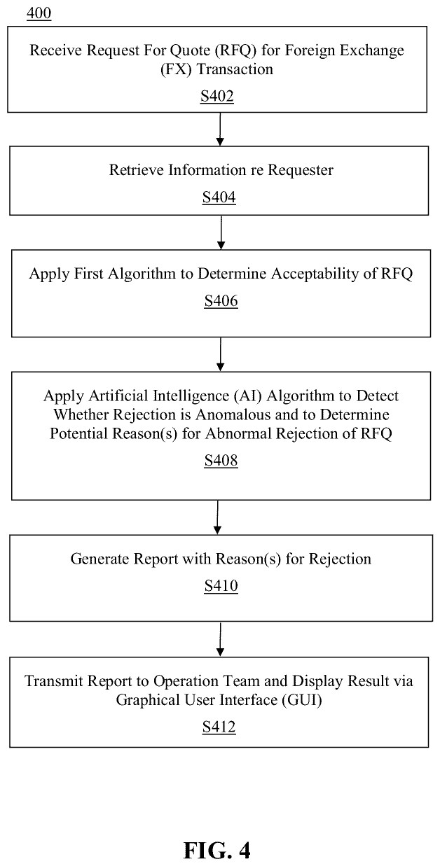

Upon being started, the anomalous rejections of FX RFQs module 302 executes a process for detecting abnormal and/or anomalous rejections of RFQs for FX transactions by using artificial intelligence techniques to obtain explanations for the rejections and to facilitate resolutions thereof so as to minimize potential losses of revenue. An exemplary process for detecting abnormal and/or anomalous rejections of RFQs for FX transactions by using artificial intelligence techniques to obtain explanations for the rejections and to facilitate resolutions thereof so as to minimize potential losses of revenue is generally indicated at flowchart 400 in FIG. 4.

In process 400 of FIG. 4, at step S402, the anomalous rejections of FX RFQs module 302 receives a request for quote (RFQ) that relates to a proposed foreign exchange (FX) transaction. The request is received from a requester, i.e., an entity, such as a customer or a client of a financial institution.

At step S404, the anomalous rejections of FX RFQs module 302 retrieves information that relates to the requester from a memory, such as, for example, customer-specific account data repository 206(1). The information that is retrieved relates to a financial capability of the requester to conduct the proposed FX transaction.

At step S406, the anomalous rejections of FX RFQs module 302 applies a first algorithm that is designed to make an initial determination as to whether the RFQ received in step S402 is acceptable. In many instances, the RFQ is deemed as being acceptable, and in this scenario, the process 400 ends, and the proposed FX transaction proceeds in a normal manner.

However, when the RFQ is initially determined in step S406 as not being acceptable, then at step S408, the anomalous rejections of FX RFQs module 302 applies a second algorithm that uses an artificial intelligence (AI) technique to detect whether the rejection is abnormal or anomalous and to determine a potential reason that the initial determination made in step S406 has indicated that the RFQ is not acceptable. In an exemplary embodiment, the potential reason may include any one of more of a first reason that is based on an abnormal behavior of the requester within a predetermined time interval, a second reason that is based on a product type that relates to the proposed FX transaction, a third reason that is based on a currency that relates to the proposed FX transaction, and a fourth reason that is based on a size of the proposed FX transaction. The predetermined time interval may include, for example, any one of a 24-hour interval, a three-day interval, a seven-day (i.e., one week) interval, a thirty-day or one-month interval, a six-month interval, a twelve-month interval, or any other suitable interval.

At step S410, the anomalous rejections of FX RFQs module 302 generates a report that includes information that relates to the potential reason for the initial determination of unacceptability of the RFQ as determined by the AI algorithm. Then, at step S412, the anomalous rejections of FX RFQs module 302 transmits the report to a predetermined destination and displays relevant portions of the report via a graphical user interface (GUI). In an exemplary embodiment, the predetermined destination includes a workstation of a person or of a group of persons, such as, for example, an operations team that includes human operators that are well-positioned to review the reason for the initial rejection of the RFQ, and to potentially take action to override the rejection as they deem appropriate.

In an exemplary embodiment, the AI algorithm uses historical information that relates to previous transactions that have been conducted by the requester as an input. In this aspect, the AI algorithm may detect a change in the behavior of the requester and/or changes in any of various aspects of the proposed transaction as compared with analogous aspects of the previous transactions. For example, if the previous transactions exhibit a pattern that indicates the use of particular types of currency and the frequency of rejection by the conventional pricing algorithm is low, and the newly proposed FX transaction would use different types of currency and is more likely to be rejected, then the AI algorithm may detect this as a change that may have triggered an initial determination that the proposed transaction is not acceptable. As another example, if the previous transactions exhibit a pattern that indicates the involvement of particular product types and the newly proposed FX transaction would involve different types of products, then the AI algorithm may detect this as a change that may have triggered an initial determination that the proposed transaction is not acceptable.

In an exemplary embodiment, in addition to the historical information that relates to previous transactions that have been conducted by the requester, the AI algorithm may also use historical information that relates to previous transactions that have been conducted by entities that are deemed as being similar to the requester. In this regard, the AI algorithm may make a determination as to whether a particular entity, such as, for example, another customer, is similar to the requester by 1) identifying a set of features of the requester; 2) identifying a corresponding set of features of the particular entity; and 3) determining a distance between the sets. In an exemplary embodiment, this determination may be made with respect to many entities, i.e., a global set of candidate entities, such as the set of existing customers of the bank; and the determination as to which entities are deemed as being similar to the requester may be made by selecting the entities for which the distances are the closest distances among the candidate entities.

In an exemplary embodiment, in addition to the historical information that relates to previous transactions that have been conducted by the requester and the historical information that relates to previous transactions that have been conducted by entities that are similar to the requester, the AI algorithm may also use historical information that relates to previous transactions that have been conducted by other entities that are not deemed as being similar. In this regard, the AI algorithm may use historical information that relates to the entirety of the global set of candidate entities.

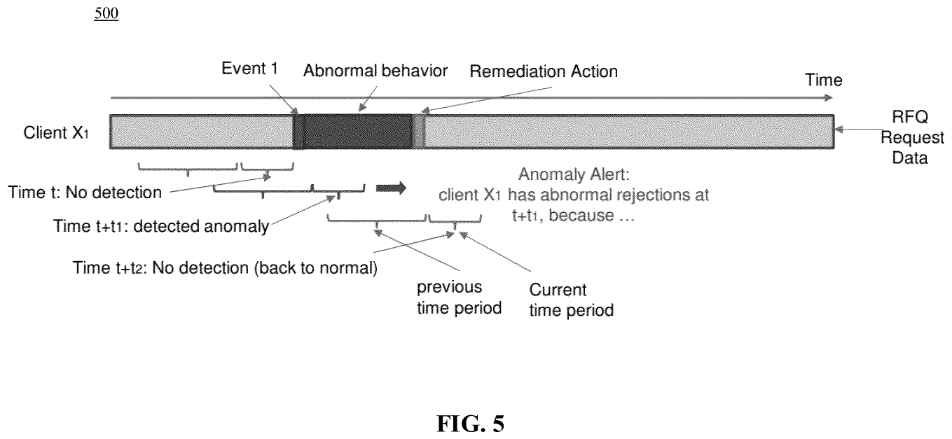

FIG. 5 is a diagram 500 that illustrates a timeline for detecting abnormal behavior, generating an anomaly alert, and performing a remediation action in a method for detecting abnormal and/or anomalous rejections of requests for quotes for foreign exchange transactions, according to an exemplary embodiment.

As illustrated in FIG. 5, for a particular customer Client X1 that has submitted an RFQ, at time t, no anomaly detection has been made, and then at time t+t1, an anomaly is detected. The detection of an anomaly gives rise to an anomaly alert, which indicates that Client X1 has an abnormal rejection at time t+t1 and provides a potential reason analysis for the rejection. The anomaly alert provides an opportunity to perform a remediation action that may enable the RFQ to be accepted, and in the timeline illustrated in FIG. 5, this remediation action occurs at time t+t2. As a result, at time t+t2, no anomaly detection is made, and the RFQ is then in condition for acceptance.

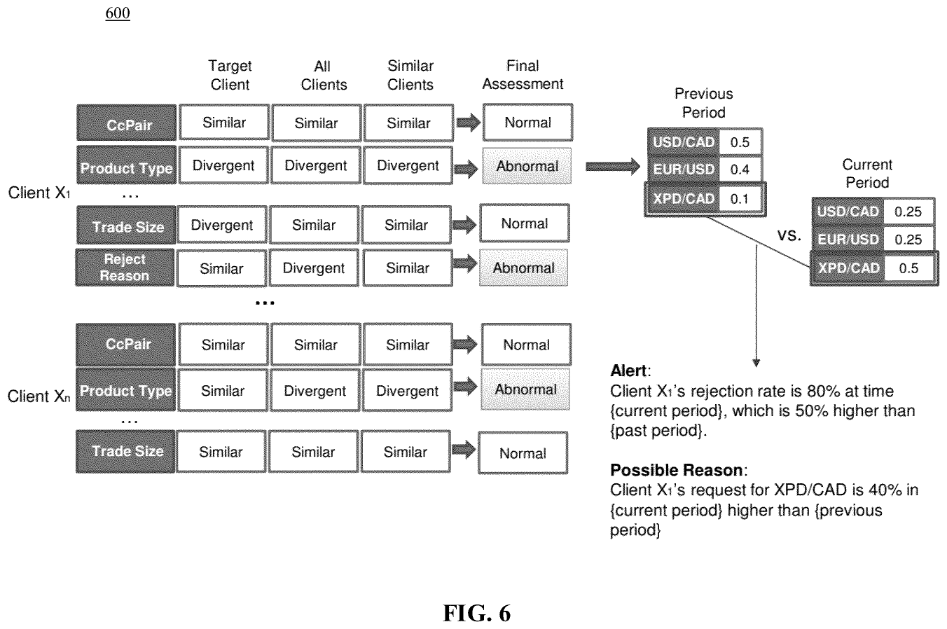

FIG. 6 is a diagram 600 that illustrates various scenarios in which rejections of requests for quotes are determined as being normal or abnormal in a method for detecting abnormal and/or anomalous rejections of requests for quotes for foreign exchange transactions, according to an exemplary embodiment, according to an exemplary embodiment.

As illustrated in FIG. 6, a table includes rows that correspond to various features of FX transactions, such as currencies used in the transactions (i.e., “CcPair”), product type, and trade size, and the table also includes columns that correspond to a requester, i.e., a “target client,” a global set of customers, i.e., “all clients,” and customers that are deemed as being relatively similar to the requester, i.e., “similar clients.” A column for “Final Assessment” indicates whether a particular rejection of an RFQ is deemed as being normal or abnormal, and the data is then processed in order to generate an anomaly alert and a possible reason for the anomaly alert. In the example illustrated in FIG. 6, the alert indicates that a particular requester has a rejection rate of 80% for a current period of time, which is 50% higher than a rejection rate for a particular past period of time; and the possible reason provided is that the requester has requested quotes that use a particular pair of currencies, i.e., palladium ounce (XPD) and Canadian dollar (CAD), at a rate that is 40% higher in the current period than in the previous period.

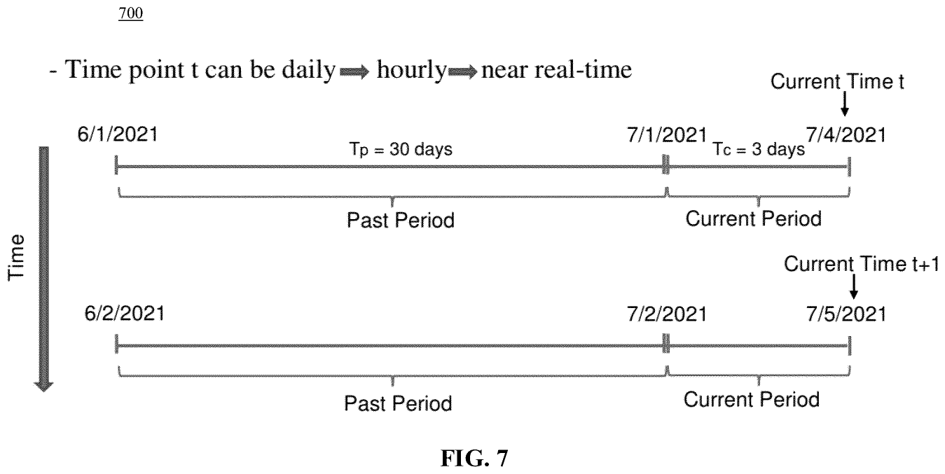

FIG. 7 is a diagram 700 that illustrates a timeline for performing a dynamic anomaly detection in a method for detecting abnormal and/or anomalous rejections of requests for quotes for foreign exchange transactions, according to an exemplary embodiment, according to an exemplary embodiment. As illustrated in FIG. 7, the current period may be a most recent three-day period, and the past period of time may be a thirty-day period that immediately precedes the current period. The current time t may indicate a particular day, a particular hour, or a near real-time moment.

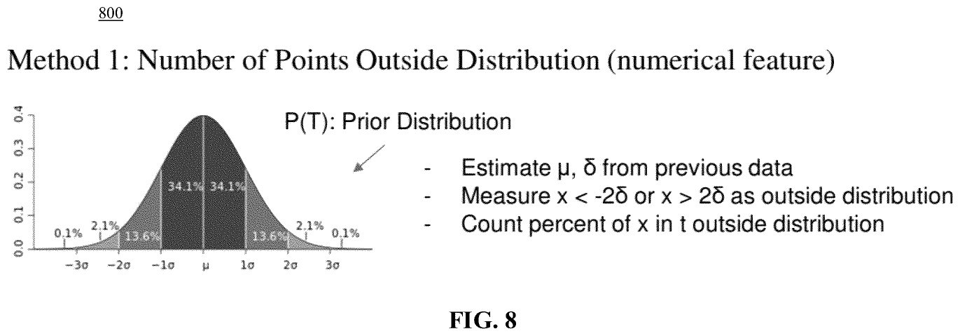

FIG. 8 is a diagram 800 that illustrates a procedure for determining a distribution of a deviation and a distance with respect to a numerical feature that relates to a reason for a rejection in a method for detecting abnormal and/or anomalous rejections of requests for quotes for foreign exchange transactions, according to an exemplary embodiment, according to an exemplary embodiment.

As illustrated in FIG. 8, for a distribution of data points that relate to a numerical feature, the AI algorithm may determine a distance by first estimating a mean value u and a standard deviation value σ from previous data that relate to the numerical feature, and then measure any current value x that is more than double the standard deviation value away from the mean value as being outside the distribution. A percentage of current values x that are outside the distribution is then computed.

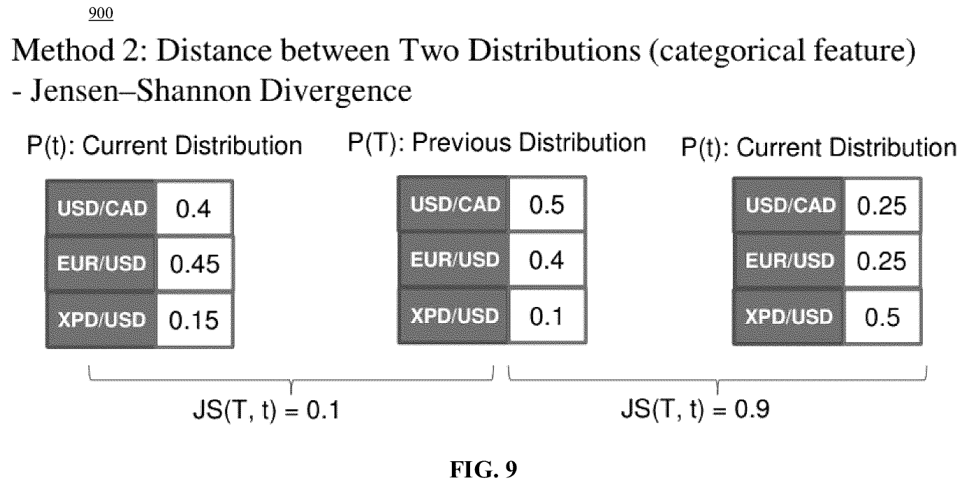

FIG. 9 is a diagram 900 that illustrates a procedure for determining a distribution of a deviation and a distance with respect to a categorical feature that relates to a reason for a rejection in a method for detecting abnormal and/or anomalous rejections of requests for quotes for foreign exchange transactions, according to an exemplary embodiment, according to an exemplary embodiment. As illustrated in FIG. 9, a distance between two distributions that correspond to a categorical feature may be computed as a Jensen-Shannon divergence. In the example illustrated in FIG. 9, the categorical feature is currency pairs used in FX transactions, and the frequency of each currency pair is used for determining the distribution.

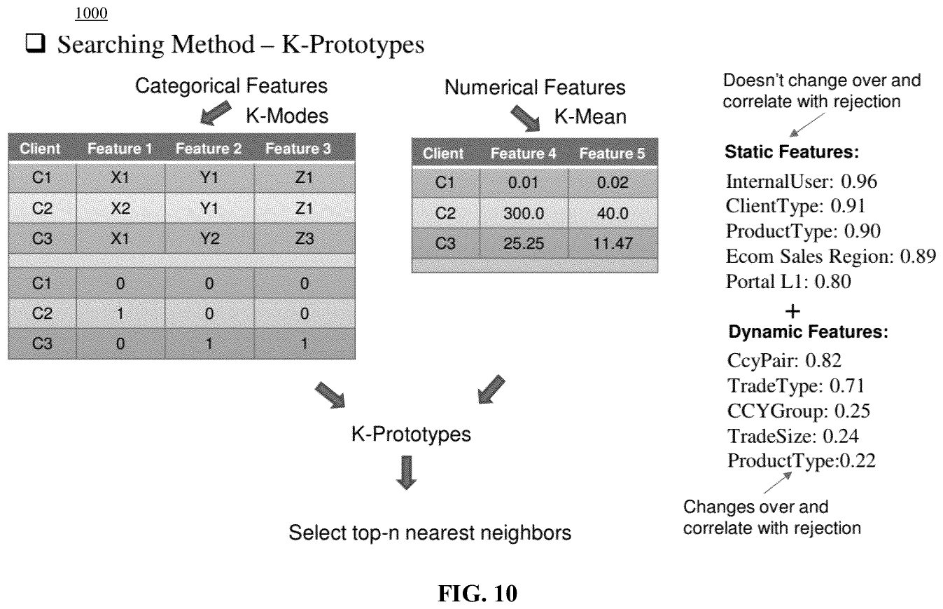

FIG. 10 is a diagram 1000 that illustrates a procedure for determining a similarity among transaction participants in a method for detecting abnormal and/or anomalous rejections of requests for quotes for foreign exchange transactions, according to an exemplary embodiment, according to an exemplary embodiment.

As illustrated in FIG. 10, the procedure includes identifying various features of each of a set of entities for which a similarity determination is to be made, and assigning a k-mode value to each categorical feature and a k-mean value to each numerical feature. Then, the k-mode values and k-mean values are used to generate k-prototypes for each entity. The determination as to similarity or lack thereof is made by selecting the top-n nearest neighbors to any particular entity from among the k-prototypes.

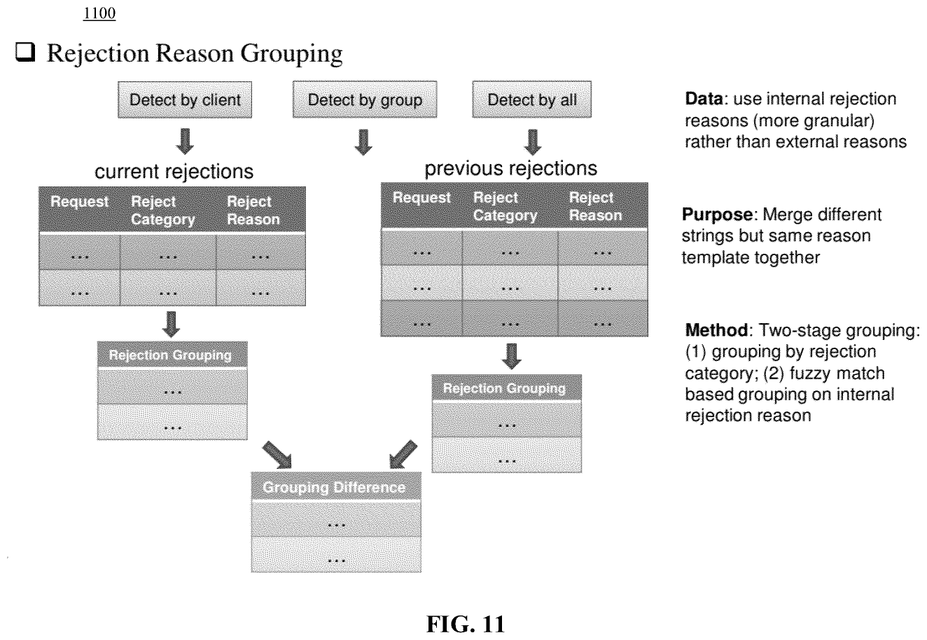

FIG. 11 is a diagram 1100 that illustrates a procedure for determining whether a rejection is anomalous or normal in a method for detecting abnormal and/or anomalous rejections of requests for quotes for foreign exchange transactions, according to an exemplary embodiment, according to an exemplary embodiment. This procedure may be implemented by the application of the AI algorithm that is designed to determine a potential reason for a rejection of an RFQ.

As illustrated in FIG. 11, a determination as to whether a rejection is anomalous or normal may be made by using a first table of current rejections that includes requests, rejection categories, and rejection reasons, and a second table of previous rejections that also includes requests, rejection categories, and rejection reasons. These two tables may be constructed for three separate groups of entities, including a first group that includes only the current requester, a second group that includes entities that are deemed as being similar to the requester, and a third group that includes a global set of candidate entities regardless of similarity to the requester. The first table and the second table may be used to construct respective rejection groupings, which are then compared to one another in order to determine a grouping difference. The groupings may be made in a two-stage process: First, the groupings may be made based on rejection category; and second, a fuzzy match-based grouping may be made based on an internal rejection reason.

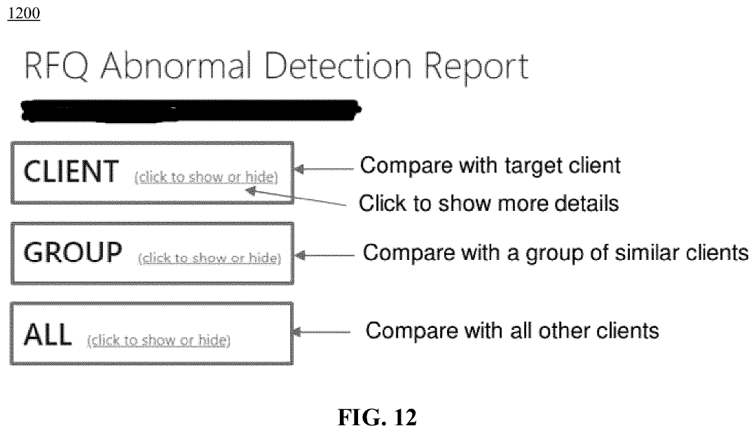

FIG. 12 is a diagram 1200 that illustrates a graphical user interface (GUI) that displays an RFQ abnormal detection report that is generated by performing a method for detecting abnormal and/or anomalous rejections of requests for quotes for foreign exchange transactions, according to an exemplary embodiment. As illustrated in FIG. 12, when an RFQ abnormal detection report is available, a GUI may display three clickable buttons that enable a user to obtain data that includes an explanation of a reason for the abnormal detection report based on 1) historical information that relates to the requester, 2) historical information that relates to a group of similar entities, and/or 3) historical information that relates to a global set of candidate entities.

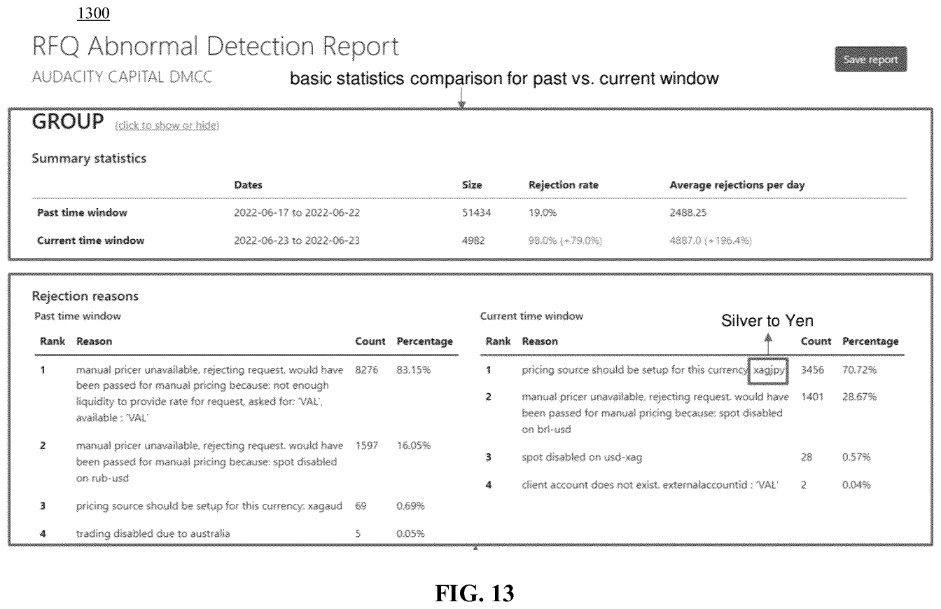

FIG. 13 is a screenshot 1300 that illustrates an example of an RFQ abnormal detection report that is generated by performing a method for detecting abnormal and/or anomalous rejections of requests for quotes for foreign exchange transactions, according to an exemplary embodiment. As illustrated in FIG. 13, an RFQ abnormal detection report may provide specific information that relates to reasons for rejections of RFQs, including summaries of statistics for a past time window and a current time window and rejection reasons for the past time window and the current time window.

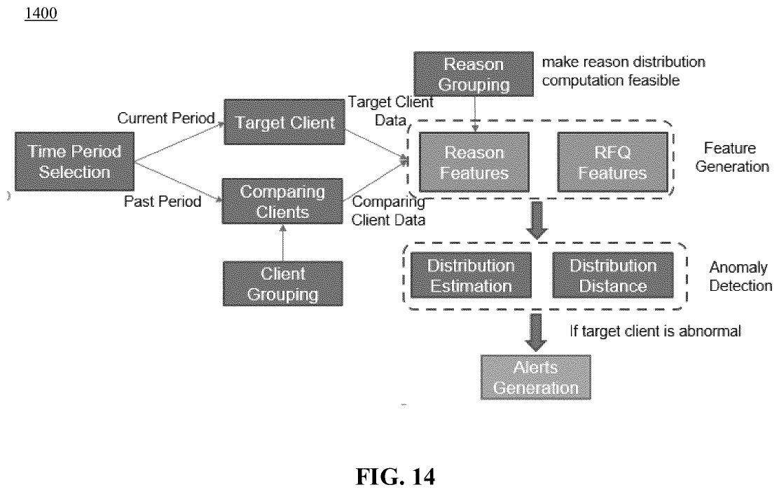

FIG. 14 is a diagram 1400 that illustrates a logic flow of a system that performs a method for detecting abnormal and/or anomalous rejections of requests for quotes for foreign exchange transactions, according to an exemplary embodiment. As illustrated in FIG. 14, the system includes a time period selection component that selects either a past period or a current period. For the current period, the system then retrieves data that pertains to the target client, i.e., historical information that indicates previous transactions that were accepted or rejected. For the past period, the system performs an operation that relates to at least one of three options: 1) retrieving data that relates to the target client; 2) retrieving data that relates to all clients; and/or 3) a client grouping operation in order to assemble a group that is relatively similar to the target client, and then compares the current proposed transaction with historical information about transactions that were accepted or rejected for the group. The outputs of the target client component and the comparing clients components are then fed into a feature generation section.

The feature generation section also receives an input from a reason grouping component that provides data that makes a reason distribution computation feasible. This input is received by a reason features component that analyzes the target client data and the comparing client data in order to determine potential reasons that a particular transaction may be accepted or rejected. The feature generation section also includes an RFQ features component that analyzes the proposed transaction in order to determine potential reasons that this specific proposed transaction may be rejected.

The outputs of the feature generation section are fed to an anomaly detection section that includes a distribution estimation component and a distribution distance component. These components analyze the inputs to make a determination as to whether a rejection of the proposed transaction may be abnormal or anomalous. When a determination is made that the rejection is abnormal, an alerts generation component is notified in order to generate an alert.

Accordingly, with this technology, an optimized process for detecting abnormal and/or anomalous rejections of requests for quotes (RFQs) for foreign exchange (FX) transactions by using artificial intelligence techniques to obtain explanations for the rejections and to facilitate resolutions thereof so as to minimize potential losses of revenue is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for detecting anomalous rejections of requests for quotes for foreign exchange transactions, the method being implemented by at least one processor, the method comprising:
receiving, by the at least one processor from a first entity, a first request for quote (RFQ) that relates to a proposed foreign exchange (FX) transaction;
retrieving, by the at least one processor from a memory, first information that relates to a financial capability of the first entity to conduct the proposed FX transaction;
applying, by the at least one processor, a first algorithm that is designed to make an initial determination as to whether the first RFQ is acceptable, based on the first RFQ and the first information;
when the initial determination indicates that the first RFQ is not acceptable, applying, by the at least one processor, a second algorithm that uses an artificial intelligence (AI) technique to determine a potential reason that the initial determination has indicated that the first RFQ is not acceptable; and
generating a report that includes information that relates to the potential reason that the initial determination has indicated that the first RFQ is not acceptable.

2. The method of claim 1, wherein the potential reason includes at least one from among a first reason that is based on an abnormal behavior of the first entity within a predetermined time interval, a second reason that is based on a product type that relates to the proposed FX transaction, a third reason that is based on a currency that relates to the proposed FX transaction, and a fourth reason that is based on a size of the proposed FX transaction.

3. The method of claim 2, wherein the predetermined time interval includes one from among a 24-hour interval, a three-day interval, a seven-day interval, a 30-day interval, a six-month interval, and a twelve-month interval.

4. The method of claim 1, wherein the second algorithm uses historical information that relates to previous transactions that have been conducted by the first entity as an input.

5. The method of claim 4, wherein the second algorithm uses historical information that relates to previous transactions that have been conducted by a plurality of second entities that are similar to the first entity as an additional input.

6. The method of claim 5, wherein the second algorithm uses historical information that relates to previous transactions that have been conducted by a plurality of third entities that are not similar to the first entity as another additional input.

7. The method of claim 6, further comprising determining whether a particular entity is similar to the first entity by:
identifying a plurality of features that relates to the first entity;
identifying, for each respective entity from among a global set of entities, a corresponding set of features that relates to the respective entity;
determining, for each respective pairing of a respective entity with the first entity, a respective distance between the plurality of features that relates to the first entity and the corresponding set of features that relates to the respective entity; and
determining, for each respective pairing, whether the corresponding entity is similar to the first entity based on the determined distance.

8. The method of claim 7, wherein each entity included in the global set of entities that is not determined as being similar to the first entity is determined as being included in the plurality of third entities.

9. The method of claim 1, further comprising transmitting the report to a predetermined destination and displaying at least a portion of the report on a display via a graphical user interface (GUI).

10. A computing apparatus for detecting anomalous rejections of requests for quotes for foreign exchange transactions, the computing apparatus comprising:
a processor;
a memory;
a display; and
a communication interface coupled to each of the processor, the memory, and the display,
wherein the processor is configured to:
receive, via the communication interface from a first entity, a first request for quote (RFQ) that relates to a proposed foreign exchange (FX) transaction;
retrieve, from the memory, first information that relates to a financial capability of the first entity to conduct the proposed FX transaction;
apply a first algorithm that is designed to make an initial determination as to whether the first RFQ is acceptable, based on the first RFQ and the first information;
when the initial determination indicates that the first RFQ is not acceptable, apply a second algorithm that uses an artificial intelligence (AI) technique to determine a potential reason that the initial determination has indicated that the first RFQ is not acceptable; and
generate a report that includes information that relates to the potential reason that the initial determination has indicated that the first RFQ is not acceptable.

11. The computing apparatus of claim 10, wherein the potential reason includes at least one from among a first reason that is based on an abnormal behavior of the first entity within a predetermined time interval, a second reason that is based on a product type that relates to the proposed FX transaction, a third reason that is based on a currency that relates to the proposed FX transaction, and a fourth reason that is based on a size of the proposed FX transaction.

12. The computing apparatus of claim 11, wherein the predetermined time interval includes one from among a 24-hour interval, a three-day interval, a seven-day interval, a 30-day interval, a six-month interval, and a twelve-month interval.

13. The computing apparatus of claim 10, wherein the second algorithm uses historical information that relates to previous transactions that have been conducted by the first entity as an input.

14. The computing apparatus of claim 13, wherein the second algorithm uses historical information that relates to previous transactions that have been conducted by a plurality of second entities that are similar to the first entity as an additional input.

15. The computing apparatus of claim 14, wherein the second algorithm uses historical information that relates to previous transactions that have been conducted by a plurality of third entities that are not similar to the first entity as another additional input.

16. The computing apparatus of claim 15, wherein the processor is further configured to determine whether a particular entity is similar to the first entity by:
identifying a plurality of features that relates to the first entity;
identifying, for each respective entity from among a global set of entities, a corresponding set of features that relates to the respective entity;
determining, for each respective pairing of a respective entity with the first entity, a respective distance between the plurality of features that relates to the first entity and the corresponding set of features that relates to the respective entity; and
determining, for each respective pairing, whether the corresponding entity is similar to the first entity based on the determined distance.

17. The computing apparatus of claim 16, wherein each entity included in the global set of entities that is not determined as being similar to the first entity is determined as being included in the plurality of third entities.

18. The computing apparatus of claim 10, wherein the processor is further configured to transmit, via the communication interface, the report to a predetermined destination and to cause the display to display at least a portion of the report via a graphical user interface (GUI).

19. A non-transitory computer readable storage medium storing instructions for detecting anomalous rejections of requests for quotes for foreign exchange transactions, the storage medium comprising executable code which, when executed by a processor, causes the processor to:
receive, from a first entity, a first request for quote (RFQ) that relates to a proposed foreign exchange (FX) transaction;
retrieve, from a memory, first information that relates to a financial capability of the first entity to conduct the proposed FX transaction;
apply a first algorithm that is designed to make an initial determination as to whether the first RFQ is acceptable, based on the first RFQ and the first information;
when the initial determination indicates that the first RFQ is not acceptable, apply a second algorithm that uses an artificial intelligence (AI) technique to determine a potential reason that the initial determination has indicated that the first RFQ is not acceptable; and
generate a report that includes information that relates to the potential reason that the initial determination has indicated that the first RFQ is not acceptable.

20. The storage medium of claim 19, wherein the potential reason includes at least one from among a first reason that is based on an abnormal behavior of the first entity within a predetermined time interval, a second reason that is based on a product type that relates to the proposed FX transaction, a third reason that is based on a currency that relates to the proposed FX transaction, and a fourth reason that is based on a size of the proposed FX transaction.
